(19) United States
(12) Patent Application Publication
(10) Pub. No.: US 2010/0177946 A1
(43) Pub. Date: Jul. 15, 2010

(54) SEMI-AUTOMATIC CONTOUR DETECTION

(76) Inventors: Marleen De Bruijne, Copenhagen (DK); Juan Eugenio Iglesias, Los Angeles, CA (US)

Correspondence Address: EDWARDS ANGELL PALMER & DODGE LLP, P.O. BOX 55874, BOSTON, MA, 02205, US

(21) Appl. No.: 12/451,510

(22) PCT Filed: May 15, 2008
(86) PCT No.: PCT/EP2008/055956

§ 371 Date: Feb. 26, 2010

(30) Foreign Application Priority Data
May 18, 2007 (GB) 0709599.5
Jun. 1, 2007 (GB) 0710540.6
Sep. 20, 2007 (GB) 0718369.2

(51) Int. Cl. G06K 9/64

(52) U.S. Cl. 382/132; 382/160

(57) ABSTRACT

A method of locating a contour of a structure in an image by processing said image including the structure is provided. A starting set of digital data representative of the image including the structure is taken, the structure in said image having annotated on it from three to ten landmark positions. A statistical model of said structure to the landmark positions annotated on the image is fitted and an initial estimate of the contour of the structure made. Using grey level information derived from points adjacent the estimated contour the contour boundary is iteratively moved to produce a final estimate of the contour of the structure.

The present invention relates to a method of locating the contour of a structure in an image.

Osteoporosis is a bone disease in which the bone mineral density (BMD) is reduced, bone micro-architecture is disrupted, and the amount and variety of non-collagenous proteins in bone is altered. Bones affected by the disease are more likely to fracture. Osteoporosis is defined by the World Health Organisation (WHO) as either a bone mineral density 2.5 standard deviations below peak bone mass (20-year-old sex-matched healthy person average) as measured by dual X-ray absorptiometry (DXA), or any fragility fracture. Due to its hormonal component, more women, particularly after menopause, suffer from this disease than men.

Osteoporotic fractures are those that occur under slight amounts of stress that would not normally lead to fractures in non-osteoporotic people. Typical fractures occur in the vertebral column, hip and wrist. Vertebral fractures are the most common ones. Occurring in younger patients, they are a good indicator of the risk of future spine and hip fractures. These two are the most serious cases, leading to limited mobility and possibly disability. Hip fractures, in particular, usually require prompt surgery, which has other important risks associated, such as deep vein thrombosis and pulmonary embolism. Although osteoporosis patients have an increased mortality rate due to the complications of fractures, most patients die with the disease rather than of it.

Vertebral fractures are conventionally detected and graded on lateral X-rays. Apart from the subjective judgement of the image by a radiologist, a standard six-point morphometry is commonly used. In this technique, six landmarks are placed on the corners and in the middle point of both vertebra endplates, defining the anterior, middle and posterior heights. These measurements can be used to calculate a fracture grade. In current clinical trials, a fractured vertebra is defined as the one for which one of the three heights is at least 20% larger than any other.

The six-point representation captures most of the important information in the image, but it is unable to capture certain structures (such as osteophytes) or subtle shape variations. Use of a full contour would overcome this problem. However, manually annotating the full contour of the vertebrae represents a huge amount of work. Accordingly, many methods have been proposed to segment vertebrae automatically or semi-automatically.

Gardner et al (SPIE Vol. 2710, February 1996, pp 996-1008) discloses a semi-automated system, based on active contour (snake) modelling of vertebrae. Points on the vertebral boundary are specified by a user on a digital image of a vertebra. The selected boundary points then act as physical constraints on an active contour that is automatically fitted to the vertebra boundary. Various parameters are monitored and adjusted to provide an appropriate degree of freedom for the snake. Too much freedom can result in an improbable shape as the snake may be misled by an unclear edge of the vertebra and too little freedom can result in sharp turns in the contour, for example the corners of the vertebra or an osteophyte, being missed.

Semi-automatic and automatic segmentation of the vertebrae in lateral x-ray images is a difficult task because of the nature of the images. Lateral x-ray images show the superimposition of many layers, making it difficult to distinguish the region of interest—a sagittal plane along the spine. This is the reason why many classical segmentation approaches, such as those based on region growing, fail.

Active shape models have the advantage that they make use of prior knowledge of vertebral shape and appearance, and therefore do not need to rely as much on the information in the images.

In Smyth et al (Radiology, May 1999, pp 571-578), a point distribution model (PDM) was used to represent the full contour of vertebrae, and a classifier to separate normal and fractured vertebrae. An improvement was observed in the performance of the full contour representation compared to that of the six landmarks. A similar conclusion was drawn in de Bruijne et al (“Vertebral Fracture Classification,” in Medical Imaging: Image Processing, J. P. Pluim and J. M. Reinhardt, eds., Proceedings of SPIE 6512, SPIE Press, 2007).

Zamora et al (Medical Imaging: Image Processing, Vol 5032 of Proceedings of SPIE, SPIE Press, 2003, pp 631-642) used an active shape model (ASM) including grey level edge information, initialising it with a customised implementation of the generalised Hough transform. They applied the method on x-ray images and achieved errors lower than 6.4 mm in 50% of the lumbar images. Smyth et al also used ASM methods to segment vertebrae in dual energy x-ray absorptiometry (DXA). They require the user to annotate the mid-points of the bottom of L4, top of T12 and top of T7. They achieved a root mean square (RMS) point-to-line error lower than 1.23 mm in 95% of the cases in healthy vertebrae, and lower than 2.24 mm in 92% of the fractures.

De Bruijne et al applied a fully automated method based on shape particle filtering, lowering the average point-to-line error to 1.mm. Roberts et al (Volume 2750 of LNCS, Springer, 2005, pp 733-840) incorporated an active appearance model (AAM) and a dynamic ordering algorithm to segment the vertebrae in DXA images. Requiring the user to mark the same three points as Smyth et al., they achieved a point-to-line error of 0.79 mm. Better results have been achieved by Roberts et al (Proceedings of Medical Image Understanding and Analysis, 2006, Vol. 1, pp 120-124), who recently reported a 0.64 mm mean point-to-line error (95% of the points 2 mm within the contour) in radiographs of healthy vertebrae. The user is required to approximately mark the center of each vertebra. The algorithm was extended to DXA images by Roberts et al (Proceeding of MICCAI Conference Workshop on joint and bone disease, 2006, Vol. 1, pp 1-8). They achieved 0.69 mm mean point-to-line errors in normal vertebrae and 0.96 in fractures.

According to a first aspect of the present invention, there is provided a method of locating a contour of a structure in an image by processing said image including the structure, comprising the steps of:

taking a starting set of digital data representative of the image including the structure, the structure in said image having annotated on it from three to ten landmark positions;

fitting a statistical model of said structure to the landmark positions annotated on the image, and making an initial estimate of the contour of the structure; and

using grey level information derived from points adjacent the estimated contour iteratively to move the contour boundary to produce a final estimate of the contour of the structure.

The invention is generally applicable to any structure in an image, for example, an x-ray, computer tomography or magnetic resonance image, which has a generally predictable shape and where there is some difference in light intensity between the structure and the background of the image. Previous images that include similar structures can then be used in the training of a statistical model that is then used to locate the contour of a structure in a new image.

The method may be used for locating body parts and specifically bones. In this respect, bones generally have a predictable shape such that a statistical model may be used with assistance from manual annotations on an image of a bone, to locate the contour of a bone.

In a preferred embodiment, the structure is a vertebra and the image is of part of a spine. The method is described, hereinafter, with reference to its application in locating the contour of a vertebra. However, it will be appreciated that the method is equally applicable to extracting a contour of any structure in an image for which a general expectation of its shape is deducible by statistical analysis of the contours of similar structures in a set of such images.

For example, the described method may also be used to locate the contour of bones in x-ray images of a hand or wrist, or to locate the contours of chambers of a heart or heart walls in MR or CT scans.

Providing multiple landmark positions on a vertebra to which a statistical model may then be fitted provides a good starting point for the iterative process of locating the edge of the vertebra. Preferably, the vertebra has annotated on it four to eight, for example six, landmark positions, one on each of the corners and one in the middle point of each vertebra endplate. Annotating vertebrae with six landmarks as described above is current standard practice. As a result, compared to standard practice, no additional manual work is required.

In an embodiment, the method comprises training the statistical model of the vertebra using information from points approximating respective contours of a set of other vertebrae. It will be appreciated that any number of points may be used that provides an approximation of the contour of the vertebrae. However, in a preferred embodiment, 20 or more points are used to approximate the contour, for example, more than 40, more than 50 or more than 60 points.

Preferably, the method further comprises training the statistical model using information from three to ten, for example, four to eight, landmark positions annotated on vertebrae in said set of other vertebrae. In a preferred embodiment six landmark positions are annotated on the set of vertebrae.

In a preferred embodiment, the set of vertebrae used in training the statistical model includes unfractured and fractured vertebrae. By including fractured vertebrae in the training, the statistical model is enabled to locate the edges of fractured vertebrae as well as unfractured vertebrae. Vertebrae with osteophytes may also be included in the training stage to increase the likelihood of finding osteophytes in new images with this method.

In an embodiment, the statistical model is a conditional point distribution model. However, it will be appreciated that if the mathematical process is appropriately adapted, other statistical shape models may alternatively be used, for example, statistical models based on spherical harmonics, Fourier descriptors, distance maps, image warps and volumetric or medial representations.

Preferably, the conditional point distribution model is constructed from information approximating the respective contours of a set of vertebrae and information of three to ten, four to eight, or six landmarks annotated on each member of said set of vertebrae.

Additionally, and/or alternatively, the conditional point distribution model is constructed from a first point distribution model constructed from information approximating the respective contours of said set of vertebrae and a second point distribution model constructed from information of three to ten, four to eight, or six landmarks annotated on each member of said set of vertebrae.

In a preferred embodiment, the initial estimate of the contour is the mean of the conditional point distribution model fitted to the landmark positions.

Preferably, the iterative movement of the estimated contour is constrained by its proximity to the current estimate of the contour. Additionally and/or alternatively, the iterative movement is constrained by the conditional covariance. These constraints reduce the search space around the initial estimate and result in plausible shapes.

Additionally and/or alternatively, the movement of the contour boundary is constrained by restricting divergence of grey level information derived from points adjacent the estimated contour with equivalent information derived from said statistical model.

Preferably, the iterative movement of the contour boundary is continued until the difference between the estimated contours at two consecutive iterations is smaller than a preset limit. For example, when the distance between consecutive contour estimations is less than 2 pixels or less than 1 pixel, the iterative process stops.

In an embodiment, a grey level profile is built by sampling grey level information in the image along the normal to the contour across each contour point.

The invention has principally been defined as a method of deriving information from a digital image. However, it is of course equally applicable as an instruction set for a computer carrying out a said method or as a suitably programmed computer.

Embodiments of the present invention will hereinafter be described, with reference to the accompanying diagrams, in which:

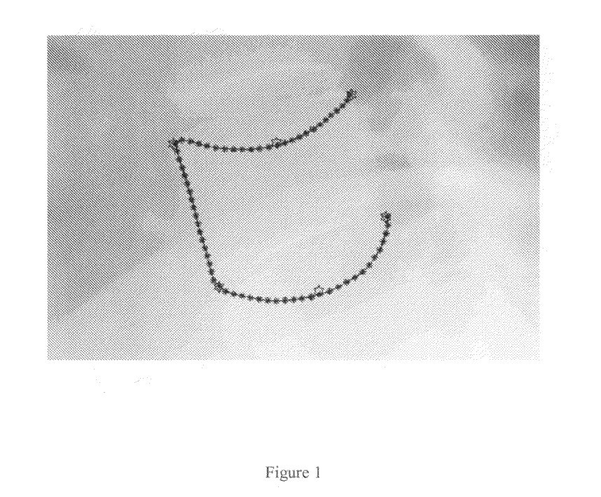

FIG. 1 shows an example of a vertebra with six initial landmark positions and the contour annotated;

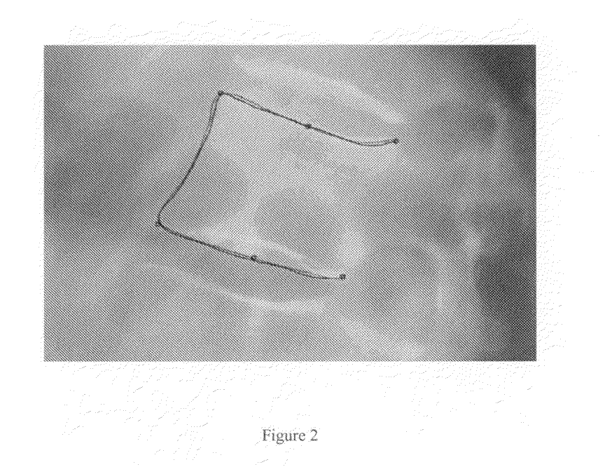

FIG. 2 shows an example of an initial estimate of the contour of a vertebra of an embodiment of the present invention;

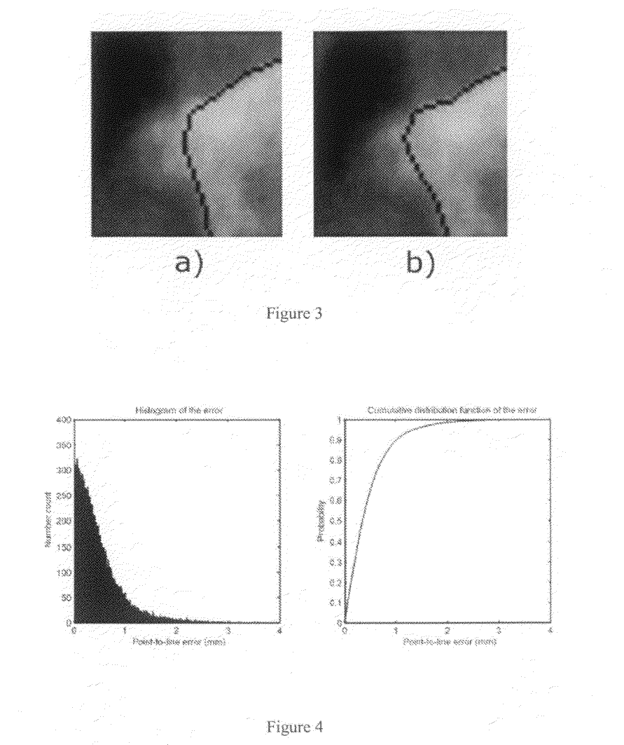

FIG. 3 illustrates the influence of the maximum allowed Mahalanobis distance on a result;

FIG. 4 shows the distance of a contour as determined by the present invention from the real contour in the form of a histogram and cumulative distribution function;

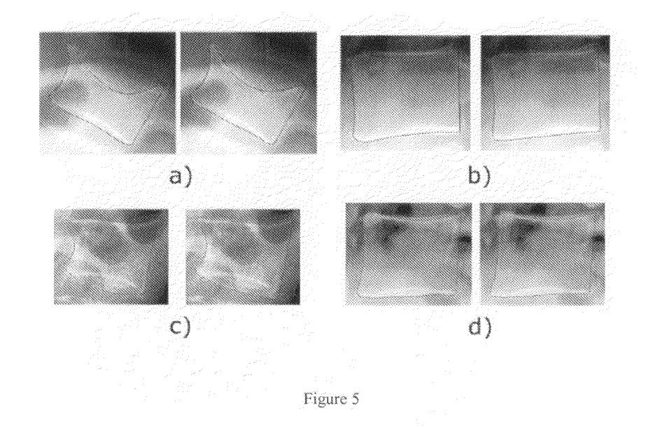

FIG. 5 shows some examples from leave-one-out experiments;

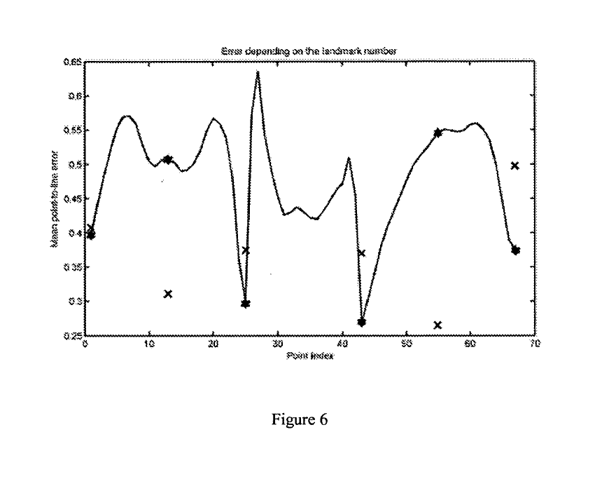

FIG. 6 shows a graph of mean point-to-line error against point index that illustrates the error depending on the point number;

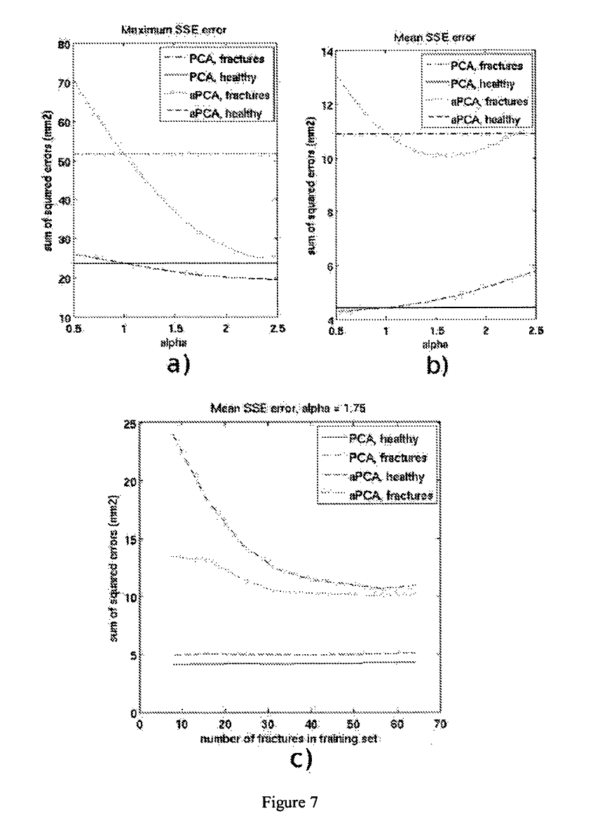

FIG. 7 shows a graph of sum of squared errors against α, where a) shows the dependence of the mean sum of squared errors with α, b) shows the dependence of the maximum sum of squared errors with α and c) shows the dependence of the mean sum of squared errors with the number of fractures present in the training set for α=1.75; and

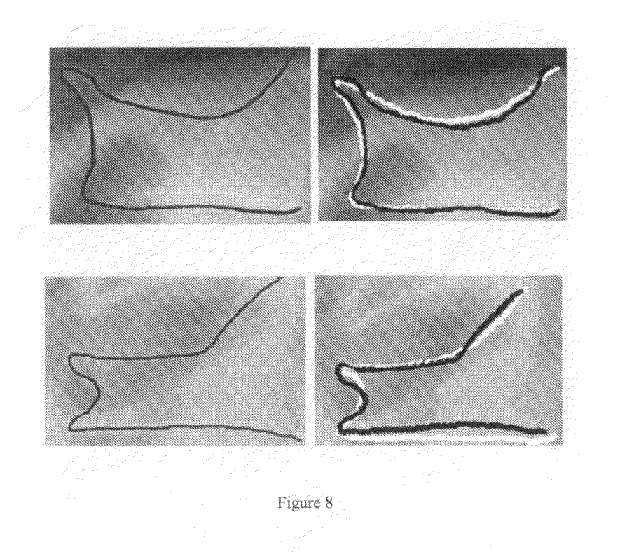

FIG. 8 shows a comparison of segmentation according to the present invention, illustrating the difference between the use of standard PCA and α-PCA.

The present invention will hereinafter be described with particular reference to the analysis of x-ray images of vertebrae of a spine. It will, however, be appreciated that the described method could be applied to other medical images of a spine for example, DXA, Computer Tomography (CT) or Magnetic Resonance (MR).

All of the steps described below are equally applicable to extracting a contour of any structure in an image for which a general expectation of its shape is deducible by statistical analysis of the contours of similar structures in a set of such images. For example, the method may be applied to extracting the contour of bones in x-ray images of a hand or wrist, or in extracting the contour of chambers of the heart and the heart walls in MR of CT scans.

The preferred method of locating a contour of a vertebra of the present invention consists of two main steps.

The first step is to construct a conditional point distribution model (PDM). For this, initially two point distribution models (PDM) are constructed, a first derived from a training set of vertebrae annotated with the traditional six landmark points, and a second derived from the same training set of vertebrae annotated with a large number of points, for example, 20 or over, that approximate the actual contour outline. The relationship between the two PDMs is then modelled to make it possible, for a new case, to construct a conditional PDM for the full contour depending on the position of six points that are manually annotated by a clinician.

The second step is then to apply this conditional PDM to a new image of a vertebra with the traditional six landmark points annotated and to approximate an initial contour of the vertebra. Active shape modelling is then used to manipulate the initial contour to find the actual contour of the vertebra subject to the constraints of the conditional PDM covariance.

The two steps above will now be described in more detail with reference to a specific example.

The training set used in this specific example consisted of information of full contours of vertebrae and sets of six landmark positions of vertebrae from 142 patients. Where, as a result of imaging and projection of a vertebra in the image, a vertebra was shown to have two contours, the lower one was always chosen. Vertebrae L1, L2, L3 and L4 were analysed, so 568 vertebrae (including 64 fractured vertebrae) were included in the study.

The images were 12-bit deep and their resolution was 570 DPI. All images were stored in DICOM format. As the application did not require such a high resolution, the images were smoothed with a Gaussian kernel and down-sampled by a factor of five.

The six landmark positions and the contours were marked for training purposes by three different radiologists. The radiologist who marked the landmark positions on an image would always annotate the contour too. In the annotation of the six landmarks, the corners are marked first and then the perpendicular bisector of the segment joining the upper corners is displayed. It serves as a guide for the radiologist, who is supposed to place a landmark on the point of minimum height, and if it is unclear, as close to the bisector as possible. The process is then repeated for the lower plate. The displayed bisectors help the radiologists be consistent throughout the annotation process, minimizing the impact of interobserver variability in the PDM.

In order to annotate the full contour, the radiologists drew a polygonal line with as many vertices as they wanted. This contour was used as the ground truth for the study. As can be seen in FIG. 1, the six landmarks and the contours were annotated in different passes without showing the earlier annotation, so they do not necessarily overlap.

A method of a preferred embodiment is based on the following steps:

### Training:

six landmarks and an approximation of the contours of vertebrae are annotated on the training images by an expert radiologist;
the vertebrae in the data set are aligned
two PDMs are constructed, a first using information of an approximation of the respective contours of a set of vertebrae, and a second using information of landmark positions annotated on each of the same set of vertebrae.

### Vertebral Edge Location:

six landmarks are marked on the actual image of a vertebra by a radiologist
a conditional model based on the position of the six landmarks on the image and on the two PDMs derived in the training stage is built for analysis
an initial solution is estimated, using the mean of the conditional model
active shape modelling is used to fit the contour to the vertebra in the image, using the conditional covariance to constrain the solution.

These steps will now be described in further detail.

An embodiment of the method is described with reference to use of point distribution models. However, it will be appreciated that the mathematic processes may be adapted to enable use of other statistical models, for example, statistical shape models based on spherical harmonics, Fourier descriptors, distance maps, image warps and volumetric or medial representations.

As a point distribution model is to be built, the contour points must be placed on the vertebrae of the training image at equivalent points of the vertebrae. The number of points can be arbitrarily chosen by the radiologist, however, it has been shown that 20 or more points is sufficient to mark the outline of the contour. When building the point distribution model, it is necessary for the number of contour points to be the same for every case. Accordingly, resampling is necessary in the contours, as the number of points marked by radiologists is likely to be inconsistent. In the training set described in this example, the maximum number of points annotated by a radiologist was 53.

For convenience, in the described embodiment, it was decided that the contour model would consist of 67 points. This allows for an equal number of points between landmarks. It will, however, be appreciated that a different, fixed, number of points could be used, provided that the number of points allows a sufficient degree of accuracy for the outline of the contour. Accordingly, to arrive at 67 points, the contour was completed, using the points marked by the radiologist, and then the 67 points were assigned to the contour. In the described embodiment, the points of the contour closest to the initial six landmark positions were chosen to be points 1, 13, 25, 43, 55 and 67. The rest of the contour points were equidistantly placed between these six. The third segment has 50% more points because it is on average (approximately) 50% longer than the other four. A sample image is shown in FIG. 1. Here the six initial landmark positions are marked as stars and the contour with selected points are marked as asterisks.

This specific example has been described with reference to the use of six landmark positions. However, it will be appreciated that a range of between three and ten landmarks may be positioned that are still, in general, representative of the shape of the vertebra.

In the following step, the 6-point representations of the vertebrae were aligned in order to eliminate translation, scale and rotation deviations between point sets. The Procrustes method was used, using only the information from the corners. The complex representation of an annotation shape can be defined as:

wᵢ=(x₁+i*y₁, x₂+i*y₂, . . . , xₙ+i*yₙ)^{T}

and generalised Procrustes alignment can be expressed as

ωᵢ^{p}=ωᵢ*\hat{μ}ωᵢ/ωᵢ*ωᵢ, i=1, 2, . . . , n

where each ωᵢ^{p} is the full Procrustes fit of ωᵢ onto \hat{μ}. The full Procrustes estimate of the mean shape [μ] can be found as the eigenvector corresponding to the largest eigenvalue of the complex sum of squares and products matrix:

$$S = {\sum }_{i = 1}^{n} {w}_{i} {w}_{i}^{*} / {w}_{i}^{*} {w}_{i} i = 1 , 2 , … n .$$

The transform parameters for each vertebra were then applied on the full contours, so that both representations were aligned. Each shape was then represented by a vector, where N=6 or N=67, depending on the model:

x=[x₁, x₂, . . . , x_{N}, y₁, y₂, . . . , y_{N}]^{t}

Once the training shapes were aligned, a point distribution model was built for both the six landmark positions and the full contour representations, mixing vertebrae L1, L2, L3 and L4 into a single model. In order to build the model, a Principal Component Analysis (PCA) was performed on the aligned data vectors. PCA is a technique that can be used to reduce the dimensionality of a dataset. It is a linear transformation towards a new coordinate system such that the greatest variance by any projection of the data lies on the first coordinate (known as the first principal component), the second greatest variance on the second coordinate, and so on. It is hence possible to simplify the dataset by keeping only the first principal components in the new representation. It can be shown that an orthonormal base of the new space is given by the eigenvectors of the covariance matrix of the dataset.

The shape model is then characterised by a mean shape χ̅, the kept eigenvalues λᵢ, i=1, . . . , k and the corresponding eigenvectors, which are grouped columnwise in the P matrix, which accomplishes that P^{t}P=I. Each shape can then be approximated by

x≈ x̅+Pb

where b can be calculated for a certain shape:

b=P^{t}(x− x̅)

and the error vector is:

=x− x̅−Pb=x− x̅−P(P^{t}(x− x̅))

where b is a column vector of k components, representing the projection of the shape onto the space of the model. Along the training set, the mean of this vector will be zero, and the covariance C will be a diagonal matrix including the k eigenvalues.

In order to verify whether a certain vector b corresponds to a plausible shape, it must be checked that it is not too far away from the mean of the model, that is, the zero vector. At the same time, plausible shapes can be generated just by taking b vectors close to the zero vector. The valid region is defined by limiting the Mahalanobis distance of b. The limit dₘₐₓ can be chosen using the chi-square distribution.

$$d = \sqrt{{b}^{t} {C}^{- 1} b} = \sqrt{{\sum }_{i = 1}^{k} ( \frac{{b}_{i}^{2}}{{λ}_{i}} )}$$

If the condition d<dₘₐₓ is not true, the b vector can be modified:

b′=b(dₘₐₓ/d)

As the number of fractures in the data set is low, compared to the number of healthy ones, their influence on the model was increased by giving them a higher weight when building it. Two different weights were given to normal and fractured vertebrae when calculating the mean and the variance of the shapes, so that their total contributions were equal. As 504 healthy and 64 fractured vertebrae were available, the weights were

$${ω}_{h} = \frac{0.5}{504} and {ω}_{f} = \frac{0.5}{64} ,$$

respectively.

As an alternative to this method of weighting, a variation on PCA (described above) can be implemented that deals with the importance of outliers. There are cases in which a small subset of samples may appear as outliers and still correspond to plausible data. This is true where some of the data obtained of vertebrae include fractured vertebrae. These may appear as outliers but the information they provide is still important. In this case, the modelling of outliers is important and rather than disregarding them, they may be used to enhance the results.

PCA is an orthogonal linear transformation that spans a subspace which approximates the data optimally in a least-squares sense. This is accomplished by maximising the variance of the transformed coordinates.

If the dimensionality of the data is to be reduced to N, an equivalent formulation of PCA is to find the N-set of orthonormal vectors, grouped in the P matrix, which minimises the error made when reconstructing the original data points in the data set. The error is measured in a L₂ norm fashion:

$$C = \sum {‖ {PP}^{t} {x}_{i} - {x}_{i} ‖}^{2}$$

where C is the cost, N is the number of training cases and xᵢ are the centred data vectors to approximate.

Least-squares is not robust when outliers are present in the dataset, as they can skew the result from the desired solution, leading to inflated error rates and distortions in statistical estimates (Hampel et al.: “Robust statistics: the approach based on influence functions” Wiley 1986). It has been attempted to reduce the impact of outliers on PCA by modifying the cost in the above equation, for example, by introducing a binary variable that is zero when a data sample is considered to be an outlier:

$${C}_{{X}_{u}} = {\sum }_{i = 1}^{N} [ {V}_{i} {‖ {PP}^{t} {x}_{i} - {x}_{i} ‖}^{2} + η ( 1 - {V}_{i} ) ]$$

where Vᵢ is the set of binary variables. The term η(1−V) prevents the optimisation from converging to the trivial solution Vᵢ=0,∀i.

In contrast to this and in contrast to directly minimising the squared data reconstruction error as in normal PCA, the presented Φ-PCA algorithm minimises:

$$C = \sum Φ [ {‖ {PP}^{t} {x}_{i} - {x}_{i} ‖}^{2} ]$$

where Φ is a twice differentiable function such that Φ(x²) is convex. The fact that Φ is twice differentiable makes it possible to use Hessian-based methods in the optimisation, providing quadratic convergence. The convexity requirement ensures the existence of just one minimum for C.

A simple and at the same time powerful form of the function is Φ(x)=x^{α}, with α>0.5 in order to accomplish the convexity condition. This special case will be called α-PCA. Large values for α (α>1, in general), will enhance the outliers, as they become more expensive compared to normal cases. In particular, α=∞ would lead to minimising the L_{∞} norm, and hence the maximum reconstruction error over shapes measured in a L₂ norm fashion. On the other hand, smaller values (0.5<α<1) will have the opposite effect, leading to a more robust PCA. The case α=0.5 minimises the L₁ norm. Finally α=1 amounts to standard PCA.

The data points xᵢ must be centred, which means that their means must be substracted from them: xᵢ=sᵢ−μ, where sᵢ represents the original, non-zero mean data samples. In the proposed algorithm, the “mean” is no longer the component-wise arithmetic mean of the data points as in the standard PCA, but the vector which minimises (assuming M dimensions for the data points):

$${C}_{{μ}^{Φ}} = {\sum }_{i = 1}^{N} Φ [ {‖ {μ}^{Φ} - {s}_{i} ‖}^{2} ] = {\sum }_{i = 1}^{N} Φ [ {\sum }_{t = 1}^{M} {( {μ}_{t}^{Φ} - {s}_{{i}_{t}} )}^{2} ]$$

Once the xᵢ vectors have been calculated the Φ-PCA which consists of searching the basis vectors P that minimise the cost function in the original equation (??), can be performed. Numberical methods will be required in both minimising C and C_{μ}, as there is no closed-form expression for μ^{φ} or P.

An important difference between standard and φ-PCA is that, in the latter, the principal components have to be recalculated if the desired dimensionality changes. In standard PCA, on the other hand, the first N₁ principal components are common for analyses with N₁ and N₂ assuming that N₂>N₁.

The expressions for the gradient and the Hessian of the cost C_{μ}_{^{φ}} are quite simple and fast to calculate. Using the component-wise arithmetic mean as initialisation, Newton's method converges rapidly to the solution:

μₙ₊₁^{Φ}=μₙ^{Φ}−[HC_{μ}_{^{Φ}}(μₙ^{Φ})]⁻¹∇C_{μ}_{^{Φ}}(μₙ^{Φ}),

where the gradient ∇C_{μ}_{^{φ}} is a column vector consisting of the first-order derivatives:

$$\frac{\partial {C}_{{μ}^{Φ}}}{\partial {μ}_{k}^{Φ}} = 2 {\sum }_{i = 1}^{N} {Φ}^{′} [ {\sum }_{l = 1}^{M} {( {μ}_{l}^{Φ} - {s}_{{i}_{l}} )}^{2} ] ( {μ}_{k}^{Φ} - {s}_{{i}_{k}} )$$

and the Hessian matrix H consists of the second-order derivatives:

$$\begin{matrix}{H}_{kk} = \frac{{\partial }^{2} {C}_{{μ}^{Φ}}}{\partial {μ}_{k}^{Φ2}} \\ = 2 {\sum }_{i = 1}^{N} \{ \begin{matrix}2 {Φ}^{″} [ {\sum }_{l = 1}^{M} {( {μ}_{l}^{Φ} - {s}_{{i}_{l}} )}^{2} ] ( {μ}_{k}^{Φ} - {s}_{{i}_{k}} ) + \\ {Φ}^{′} [ {\sum }_{m = 1}^{M} {( {μ}_{m}^{Φ} - {s}_{{i}_{m}} )}^{2} ]\end{matrix} \}\end{matrix}$$

$$\begin{matrix}{H}_{bu} = {H}_{uk} \\ = \frac{{\partial }^{2} {C}_{{μ}^{Φ}}}{\partial {μ}_{k}^{Φ} \partial {μ}_{u}^{Φ}} \\ = 4 {\sum }_{i = 1}^{N} {Φ}^{″} [ {\sum }_{l = 1}^{M} {( {μ}_{l}^{Φ} - {s}_{{i}_{l}} )}^{2} ] ( {μ}_{k}^{Φ} - {s}_{{i}_{k}} ) ( {μ}_{u}^{Φ} - {s}_{{i}_{u}} )\end{matrix}$$

Once the mean has been subtracted from the data points, the original cost C must be minimised. The function has the interesting property that it reaches its global minimum for an orthonormal P matrix such that P^{t}P=I. This makes it possible not to have to constrain P to accomplish this condition during the optimisation, even it that implies that in general PP^{t} will not represent a projection matrix, and hence PP^{t}xᵢ−xᵢ does not express the reconstruction error any longer.

In the minimisation problem, only the expression for the gradient is implemented, as the one for the Hessian matrix is too complex and its computation too expensive. Using matrix calculus, all the partial derivatives can be calculated simultaneously:

$$\begin{matrix}\frac{d C}{d P} = \frac{d}{d P} {\sum }_{i = 1}^{N} Φ [ {‖ {PP}^{t} {x}_{i} - {x}_{i} ‖}^{2} ] \\ = {\sum }_{i = 1}^{N} \frac{d}{d P} Φ [ {( {PP}^{t} {x}_{i} - {x}_{i} )}^{t} ( {PP}^{t} {x}_{i} - {x}_{i} ) ] = … \\ {\sum }_{i = 1}^{N} {Φ}^{′} [ \begin{matrix}{x}_{i}^{t} {PP}^{t} {PP}^{t} {x}_{i} - \\ {x}_{i}^{t} {x}_{i} - 2 {x}_{i}^{t} {PP}^{t} {x}_{i}\end{matrix} ] [ \begin{matrix}- 4 {x}_{i} {x}_{i}^{t} P + \\ 2 [ {x}_{i} {x}_{i}^{t} {PP}^{t} + {PP}^{t} {x}_{i} {x}_{i}^{t} ] P\end{matrix} ]\end{matrix}$$

Once the gradient is known, different standard techniques can be used to update P. In a simple gradient descent scheme, for example:

$${P}_{n + 1} = {P}_{n} - k \frac{d C}{d P}$$

where k is the step size.

Line search can then be used with a normal PCA as initialisation in order to quickly keep the optimal P. In this algorithm, different step sizes are probed at each iteration, keeping the one that leads to the minimum value of the cost function C. It is important to mention that the orthonormality condition, which would simplify the expressions of the cost and the gradient, cannot be assumed throughout the process, as the P matrix is being modified unconstrainedly (even though it converges to an orthonormal matrix).

In shape models (Cootes et al. 1995), a set of landmarks is defined on a set of previously aligned shapes. One data vector sᵢ is built per shape by stacking of the x and y coordinates of the landmarks. Next, the mean is subtracted from them and PCA performed on the resulting xᵢ data vectors, aiming at representing the shapes with a lower dimensionality and with a higher specificity than the explicit Cartesian coordinates, at the expense of a certain approximation error. The differences between shape models based on standard and φ-PCA will be described.

First, the shapes are aligned with the Procrustes method and their mean calculated. Rotation, translation and scaling are allowed for aligning the shapes. The alignment parameters and the mean are optimised simultaneously, minimising:

$$\begin{matrix}{C}_{align} = {\sum }_{i = 1}^{N} Φ [ {‖ {T}_{i} ( {z}_{i} , {θ}_{i} ) - {μ}^{Φ} ‖}^{2} ] \\ = {\sum }_{i = 1}^{N} Φ [ {‖ {s}_{i} - {μ}^{Φ} ‖}^{2} ] \\ = {\sum }_{i = 1}^{N} Φ [ {‖ {x}_{i} ‖}^{2} ]\end{matrix}$$

where Tᵢ(zᵢ,θᵢ) represents the aligned sᵢ shape according to the set of parameters θᵢ. The constraint μ^{t}μ=1 prevents the shapes from shrinking towards zero. The iterative algorithm described in Cootes et al. was used for solving the problem:
1. Normalise the size of the first shape and use it as a first estimate of the mean.
2. Align all the shapes to the current estimate of the mean.
3. Update the estimate of the mean by finding the mean of the aligned shapes.
4. Normalise the size of the new estimate of the mean.
5. Go to step 2 until convergence.

The mean in the third step must be found by numerically minimising the cost. However, as minimising φ(t²) is equivalent to minimising t²=∥PP^{t}x−x∥², the alignments in the second step can be easily calculated by minimising the sum of squared distances in the standard way. Another consequence of this property is that the PCA coordinates of bᵢ of a shape can still be calculated in the same way as in the normal PCA:

sᵢ≈μ^{φ}+Pbᵢ

bᵢ=P^{t}(sᵢ−μ^{φ})

The distribution of the principal components of the full-contour model F can be modelled as a conditional Gaussian, dependent on the principal components of the landmark positions L. If μ_{F}, μ_{L}, Σ_{F}, Σ_{L} are the means and covariances of the principal components for the two models across the training data, and Σ_{FL}, Σ_{LF} represent their cross-covariances, it is then possible to write:

P(F|L)=N(μ,Σ)

μ=μ_{F}+Σ_{FL}Σ_{LL}⁻¹(L−μ_{L})=Σ_{FL}Σ_{LL}⁻¹L

Σ=Σ_{FF}−Σ_{FL}Σ_{LL}⁻¹Σ_{LF}

where μ is the conditional mean and Σ the conditional covariance matrix for the principal component coordinates of the full contour given the principal component coordinates L of the six points.

It is also possible to model the position of the points and landmarks instead of the principal components. The latter has an advantage as the size of the covariance matrices is smaller. If the coordinates of the points are used directly, Σ_{LL} might become non-invertible due to multi-collinearity in the positions, and regularisation would be required.

As shown in FIG. 2, the mean of the conditional model can be used as initialisation and the covariance is useful when fitting the model to the images. The conditional covariance is in general much “smaller” than the unconditional covariance of C: the differential entropy of the distribution decreases almost 10 logarithmic units from the unconditional to the conditional model (from −13.88 to −23.85). It is thus possible to look for the solution around the conditional mean, in a region limited by a certain value of Mahalanobis distance defined according to the new conditional covariance. The search space will hence be reduced, making it easier to fit the model and making shapes relatively far away from the six landmark positions unlikely.

In an embodiment having fewer or more than six landmarks, these landmark positions will be used in the same way as in the described embodiment when calculating the conditional covariance.

In the described example, the six landmarks in the training data are not constrained to stay on their corresponding points on the contour. The lack of this constraint allows the 11-D full contour conditional shape model to represent exactly the same shapes as the non-conditional one, although with higher Mahalanobis distances and hence smaller likelihood. This is important because it allows the conditional covariance matrix to remain full-rank, and thus invertible.

The active shape model (ASM) is an iterative algorithm that tries to fit the shape model to the contours of the vertebrae in the image. The first step is to find the translation (tₓ,t_{y}), rotation (Θ) and scale (s) parameters that best fit the corners of the six given landmark positions to the mean of the shape model. These pose parameters define the transform that allows to switch between the positions of the points in the image X (in “physical” coordinates), and their positions in the shape model “normalised” coordinates x. The pose parameters will be kept constant throughout the process.

Starting from an initial solution, which is calculated in the “normalised” coordinates with the six landmark positions, a translation along the normal to the contour is proposed for every contour point in the model at each iteration. In order to calculate it, a set of candidate positions t are selected along the normal to the contour at each contour point. A grey value profile is then built for each t by sampling the grey levels in the image along the normal to the contour and around the point t. The derivative is calculated for the points in the profile, and then scaled so that the sum of the absolute values of the derivative profile is one. This makes the algorithm robust against contrast variations. The resulting profiles pᵢ(t) are then compared to the ones of the training cases on the contour at the same contour position.

If pᵢ(t) represents the vector of normalised derivatives around point t in the profile around contour point i (let us say in the interval [t−Tₜ,t+Tₜ]), a fitness function ƒᵢ(t) can be calculated for each t by comparing pᵢ(t) to the model built from the training examples (with semilength Tₜ):

ƒᵢ(t)=(pᵢ(t)− p̅ᵢ)^{t}Sₚᵢ⁻¹(pᵢ(t)− p̅ᵢ)

where p̅ᵢ is the average of the profiles of length 2Tₜ+1 around point i in the training cases, and Sₚᵢ; is a diagonal matrix including the (independent) variances of each element in the profile. The function ƒᵢ(t) will just be defined in the interval [−Tₚ,Tₚ]. Hence, Tₚ defines how far from the current point location the search for the contour is performed. If tₘ minimises ƒ(t), the shift

$$\frac{2}{3} {t}_{m}$$

is chosen to make the algorithm evolve in a smoother way.

This new desired shape X+dX is translated into the normalised coordinates, becoming x+dx. The shape model parameters b are then updated to fit x+dx as well as possible:

(P^{t}W_{S})dx=(P^{t}WₛP)db

where Wₛ is a diagonal matrix with weights that measure the importance of each point in the fitting. The weights depend on the magnitude of the displacement and on the goodness of the fit:

$${ω}_{i}^{′} = \frac{1}{2 + {\vert d {X}_{i} \vert}^{2}} \frac{1}{{f}_{i} ( {t}_{m} )}$$

$${ω}_{i} = \frac{{ω}_{i}^{′}}{\sum {ω}_{j}^{′}}$$

Before updating the contour, it is important to check that db leads to a plausible shape. It is at this point that the information in the covariance of the conditional model becomes useful.

$$d = {\sqrt{{( {b}_{i + 1}^{′} - μ )}^{t} {\sum }^{- 1} ( {b}_{i + 1}^{′} - μ )}}^{{b}_{i + 1}^{′} = {b}_{i} + db}$$

$$and then$$

$${b}_{i + 1} = \{ \begin{matrix}{b}_{i + 1}^{′} , & if d \leq {d}_{max} \\ μ + ( {b}_{i + 1}^{′} - μ ) ( {d}_{max} / d ) , & if d > {d}_{max}\end{matrix}$$

Hence, dₘₐₓ is the parameter that controls how free the algorithm is to fit the contour to the edges in the image. A large value allows the result to move around the principal component space, which can lead to implausible solutions if the edges are not clear in the image. A small value makes the algorithm rely mostly on the model, leading to more conservative solutions, closer to the mean of the distribution. This can prevent the algorithm from finding the correct solution, especially in abnormal cases with fractures or osteophytes, in which the solution is relatively far from the initialisation in the principal component space, as shown in FIG. 3. Specifically, FIG. 3 shows the influence of maximum allowed by Mahalanobis distance on the result. In FIG. 3(a) the shape model is unable to fit the contour to the osteophyte. In FIG. 3(b) the threshold has been increased by 1.5 and the contour approximates the osteophyte better.

The new coordinates are easily calculated using:

x≈ x̅+Pb

and then transformed back to physical coordinates by the transform defined by −tₓ, −t_{y}, −Θ, s⁻¹. A new translation is then proposed for each point once more, starting a new iteration. When the difference between the shapes at two consecutive iterations is smaller than a certain limit, the process stops. For example, when the distance between consecutive estimated contours is less than 2 pixels or less than 1 pixel, the iterative process stops.

First of all, several preliminary experiments were run in order to find suitable values for the different parameters in the algorithm. Regarding the selection of the number of principal components to be kept, it depends on the proportion of the variance to be preserved. Seven and eleven components, for the six landmarks and the full contour respectively, were enough to keep approximately 97% of the total variance. From that point on, raising the proportion becomes very expensive in terms of the number of principal components.

Regarding the profile lengths, it was found that using a grey value model profile semilength Tₜ=12 pixels (2.7 mm) and making Tₚ=8 pixels (1.8 mm) leads to good results. Tₚ represents how far from the current solution one tries to find the contour. Making this parameter too large would make the search profile too long and hence make it more likely that the algorithm captures a wrong edge, especially if this edge does not represent an implausible shape. This typically happens in the type of “double contour” cases shown in FIG. 5(b).

Finally, the choice of the maximum Mahalanobis distance dₘₐₓ was made with the help of the χ² distribution for eleven degrees of freedom. Arbitrarily fixing a 10% tail probability, a compromise limit equal to 4.1 was picked. All the parameters were kept fixed for all the further experiments, unless additional description is provided.

A leave one out experiment was carried out. For each vertebra, a complete model (six landmarks, full contour, profiles) was built from the other images and used for the contour location. The distance between each point of the physician-annotated contour and the closest point in the detected contour (point-to-line distance) was calculated for each vertebra. The distribution of the error is represented in FIG. 4. Specifically, FIG. 4 shows the distance to real contour in the form of a histogram and cumulative distribution function.

The RMS error was equal to 0.68 mm, while the mean error was 0.48 mm and its standard deviation was 0.48 mm. 89% of the points were located within 1 mm of the manually annotated contour, 96% within 1.5 mm and 98% within 2 mm. The average of the maximum errors in each vertebra was 1.53 mm.

The fact that fractures were given a higher weight when building the model prevents the performance of the model from decreasing too much when fitting shapes corresponding to fractured vertebrae. The mean error for the fractures was 0.54 mm. 86% of the points were 1 mm within the real contour in fractures, and 94% within 1.5 mm.

The results were also judged visually, especially in cases with osteophytes and fractures, in which the contour may be oversmoothed. Some sample images are shown in FIG. 5. As can be seen, the model has difficulties approximating the ground truth when the ground truth takes an abrupt turn (like around osteophytes), but otherwise works quite well, as the quantitative results suggest.

It is also important to note that the results are not very sensitive to changes in the different tuned parameters. The increments in the mean error when changing the main parameters are:

For the profile length used for building the model: 4 μm in a 4 pixels wide region around the chosen value;

For the profile length used in the contour search: 6 μm in a 4 pixels wide region around the chosen value; and

For the cut-off Mahalanobis distance: 25 μm in a 1 unit wide region around the chosen value.

These values suggest that the method is robust against non-optimal choices of the parameters. The cut-off Mahalanobis distance is the one that affects the results the most, representing a trade-off between freedom (better approximation to outliers) and safety (lower likelihood of implausible shapes). The profile lengths affect mostly the convergence speed.

In the preferred embodiment, higher weights are given when building the model to fractures, lowering the overall mean performance but increasing the accuracy in the most difficult cases and hence lowering the largest errors, too. In spite of that, an average point-to-line error lower than 0.5 mm was achieved. 95% of the errors were lower than 1.36 mm. The performance is higher than those of the most recent systems described.

By annotating the six points and the full contour in different passes, the solution is not constrained to pass through the six landmarks. This adds flexibility to the shape model, making it possible for it to fit a wider range of different shapes. The fact that different radiologists made the annotations also adds some interesting variability to the model.

FIG. 6 shows an illustration of the error depending on the point number. The points corresponding to the six landmarks are marked with a star and the distances from the manually placed landmarks to the true contour are marked with crosses. It is clear here that the mean position error peaks clearly just after the third landmark and just before the fourth, which are the typical locations of osteophytes. The curve has local minima around the points corresponding to the landmarks, except for the middle point of the lower endplate. This is possible because the six landmarks are not constrained to be on the contour. The mean distances from these points to the contour are marked with crosses in the same figure.

In an embodiment, further training cases including osteophytes could be used, or a higher weighting could be given to such cases, as with the fractures. Alternatively, more flexibility could be allowed for the ASM around points 27 and 41 (the typical locations for osteophytes), for example by modifying the contour with some kind of smooth curve to fit the points. A more complex solution could be to improve the correspondence of the points around the osteophytes. Minimum description length (MDL), in which the best hypothesis for a given set of data is the one that leads to a largest compression, can be used for choosing corresponding points.

Results are also provided of an alternative dataset based on the alternative weighting applied to outliers using α-PCA. The study is based on a dataset which consists of lateral X-rays from the spine of 141 patients. Vertebrae L1 through L4 were outlined by three different expert radiologists, providing the ground truth of the study. 65 landmarks were extracted for each vertebra using the MDL algorithm, described in Thodberg “Description Length Shape and Appearance Models”, proceedings of Information Processing in Medical Imaging (2003) Springer. The same radiologists also provided information regarding the fracture type (wedge, biconcave, crush) and grade (mild, medium, severe) for the vertebrae. In addition, they also annotated the six landmarks used in the standard six-point morphometry, located on the corners and in the middle point of both vertebra endplates. These points define the anterior, middle and posterior heights, which are used to estimate the fracture grade and type.

Both normal PCA and α-PCA (for different values of α) were applied on the dataset keeping 7 (α-) PCA coordinates, capable of preserving approximately 95% of the toal variance in the data in all the cases. For both algorithms the mean and maximum squared reconstruction errors were calculated. The dependence of the error on the number of fractures in the training set was also studied. It should be noted that a higher number of components would achieve better precision and still provide a good trade-off with respect to the specificity of the model, but a smaller amount was kept in this experiment in order to better illustrate the difference between PCA and α-PCA.

Finally, PCA and α-PCA were tested in an active shape model for segmenting the L1-L4 vertebrae in the images. Two shape models were built, one for the six landmarks and the other for the full contour, and the relationship between the (α-) PCA coordinates of both models fitted to a conditional Gaussian distribution. In order to allow for more flexibility in the model, a higher number of principle components was utilised, seven for the six landmarks and eleven for the complete contour, keeping approximately 98% of the total variance in both cases.

The mean of the conditional distribution was used as initialisation for the segmentation of the full contour. At each iteration, the gray level information along a profile perpendicular to the contour was used to calculate a desired position for each point at the following looping. The new contour can then be calculated by fitting the model to the new points. The conditional covariance was used to measure the Mahalanobis distance from the new (α-) PCA coordinates b to the conditional mean. In case of it being larger than a certain threshold Dₘₐₓ, the vector is scaled down b′=b(Dₘₐₓ/D(b) to ensure D(b)≦Dₘₐₓ. This way, the solution is constrained to stay close to the six landmarks. The process is repeated until convergence.

FIGS. 7(a) and 7(b) show the dependence on α of the sum of squared errors when fitting the model to labelled points. The maximum error decreases with α as expected doing it faster for the fractures. The mean error shows how values of α lower than one tend to increase the error in fractures, as they are no longer important in the model, and decrease it in unfractured vertebrae, even if not by much. Unfractured vertebrae are in general quite well modelled already. Values larger than one initially improve the results in fractures, at the expense of making them slightly worse in unfractured vertebrae. Finally, if α increases too much, the model tends to fit merely the most unlikely cases, making the average results worse both for unfractured vertebrae and mild fractures.

In this experiment, the model was built with all the unfractured vertebrae and different fractions of the total amount of available fractures: from 12.5% to 100% in 12.5% increments. α was set to 1.75, providing a good trade-off between the maximum and mean errors in fractured and unfractured vertebrae, according to the results presented above. FIG. 7 (c) shows that α-PCA is especially useful, clearly outperforming the normal PCA, when the number of fractures in the training set is relatively small.

Vertebrae L1 through L4 were segmented from the available images using a shape model conditioned on the six landmarks annotated by the radiologists, using both standard and α-PCA (α=1.75). The experiments were performed in a leave-one-out fashion: the model used for segmenting a certain image is built upon all the other ones.

The point-to-line errors from the true contour to the output of the algorithm are displayed in the table below, along with the p-values resulting from a paired, double-sided t-test and a paired, double-sided Wilcoxon signed rank test. The results show that the standard PCA leads to a lower mean error in unfractured vertebrae, but α-PCA provides more uniform results along the different grades of fractures severity, at the expense of a slight increase in the total mean error. Moreover, α-PCA significantly outperforms the standard PCA in fractures, especially in the severe ones. It also has the property of assigning different importance to each case in a continuous manner without requiring fracture information for the training data. If this information was available, it would be possible to build two different models, but then a large number of training fractures would be required. Regarding the p-values, both tests indicate that the difference in the means between the two setups is significant.

| | | Error | Error | | |
|---|---|---|---|---|---|
| | No. | PCA | α-PCA | | p signed |
| | shapes | (mm) | (mm) | p t-test | rank |
| Unfractured | 500 | 0.44 | 0.47 | 1.79 · 10⁻⁴ | 6.05 · 10⁻⁴ |
| Mild fractures | 15 | 0.62 | 0.56 | 1.14 · 10⁻² | 1.25 · 10⁻² |
| Medium fractures | 38 | 0.66 | 0.57 | 7.87 · 10⁻³ | 1.40 · 10⁻² |
| Severe fractures | 11 | 0.97 | 0.60 | 4.78 · 10⁻³ | 9.77 · 10⁻³ |
| All fractures | 64 | 0.70 | 0.57 | 3.10 · 10⁻¹¹ | 3.53 · 10⁻¹² |

Finally, two radiographs which have been segmented with a standard and α-PCA (α=1.75) are displayed along with the contour provided by the radiologists in FIG. 8. They both correspond to sever fractures. α-PCA provides a better approximation of the real shape, especially around the points in which it changes its direction rapidly.

It will be appreciated that modifications of, and alterations to, the embodiments as described and illustrated may be made within the scope of this application.

1. A method of locating a contour of a structure in an image by processing said image including the structure, comprising the steps of:
taking a starting set of digital data representative of the image including the structure, the structure in said image having annotated on it from three to ten landmark positions;
fitting a statistical model of said structure to the landmark positions annotated on the image, and making an initial estimate of the contour of the structure; and
using grey level information derived from points adjacent the estimated contour iteratively to move the contour boundary to produce a final estimate of the contour of the structure.

2. A method as claimed in claim 1, wherein the structure is a bone.

3. A method as claimed in claim 1, wherein the structure is a vertebra and the image is of part of a spine including said vertebra.

4. A method as claimed in claim 3, further comprising training the statistical model of the vertebra using information from points approximating respective contours of a set of other vertebrae.

5. A method as claimed in claim 4, further comprising training the statistical model using information from three to ten landmark positions annotated on vertebrae in said set of other vertebrae.

6. A method as claimed in claim 4, wherein the set of vertebrae used in training the statistical model includes unfractured and fractured vertebrae.

7. A method as claimed in claim 1, wherein the statistical model is a conditional point distribution model.

8. A method as claimed in claim 7, wherein the conditional point distribution model is constructed from information approximating the respective contours of a set of vertebrae and from information of three to ten landmarks annotated on said set of vertebrae.

9. A method as claimed in claim 7, wherein the conditional point distribution model is constructed from a first point distribution model constructed from information approximating the respective contours of a set of vertebrae and a second point distribution model constructed from information of three to ten landmarks annotated on said set of vertebrae.

10. A method as claimed in claim 7, wherein the conditional point distribution model is a conditional Gaussian dependent on the positions of the landmark positions in the image being processed.

11. A method as claimed in claim 10, wherein the conditional point distribution model is a conditional Gaussian modelling the principal components of the point distribution model constructed from information approximating the respective contours of a set of vertebrae, dependent on the principal component coordinates of the six landmark positions in the image being processed.

12. A method as claimed in claim 7, wherein the initial estimate of the contour is the mean of the conditional point distribution model fitted to the landmark positions.

13. A method as claimed in claim 1, wherein the iterative movement of the estimated contour is constrained by the conditional covariance and the proximity of the conditional mean to the current estimate of the contour.

14. A method as claimed in claim 1, wherein the movement of the contour boundary is constrained by restricting divergence of grey level information derived from points adjacent the estimated contour with equivalent information derived from said statistical model.

15. A method as claimed in claim 1, wherein the iterative movement of the contour boundary is continued until the difference between the estimated contours at two consecutive iterations is smaller than a preset limit.

16. A method as claimed in claim 1, wherein a grey level profile is built by sampling grey level information in the image along the normal to the contour across each contour point.
